(19) United States
(12) Patent Application Publication
(10) Pub. No.: US 2025/0065939 A1
(43) Pub. Date: Feb. 27, 2025

(54) DAMPING DEVICE AND SEAT OF STROLLER, AND STROLLER

(71) Applicant: Wonderland Switzerland AG, Steinhausen (CH)

(72) Inventor: Xiaojian ZHANG, Dongguan, Guangdong (CN)

(73) Assignee: Wonderland Switzerland AG, Steinhausen (CH)

(21) Appl. No.: 18/728,717

(22) PCT Filed: Jan. 13, 2023
(86) PCT No.: PCT/EP2023/050776

§ 371 Date: Jul. 12, 2024

(30) Foreign Application Priority Data
Jan. 14, 2022 (CN) 202210046772.3

(51) Int. Cl. B62B 9/18

(52) U.S. Cl. CPC B62B 9/185

(57) ABSTRACT

A damping device is arranged on a first pipe (101) and a second pipe (102) of a seat pipe (100) of the stroller, which are parallel to each other, and carries a seat part of the stroller. The damping device comprises a bracket structure (10, 20) pivotally connected to the first pipe and the second pipe. The bracket structure is arranged to elastically prevent the bracket structure from pivoting relative to the first pipe and the second pipe by means of a damping elastic element to delay a downward movement of the seat part. The damping device of the stroller enables the stroller to achieve better damping effect.

### TECHNICAL FIELD

The present disclosure relates to a damping device and a seat of a stroller, and a stroller.

### BACKGROUND

Generally, strollers are used to take children outdoors. With the development of technology, requirements for strollers are also increasing. The existing stroller is generally not provided with a damping structure on its seat, so that when the stroller rides through the bumpy road, the child sitting in the stroller may feel uncomfortable, which will affect the riding comfort.

Thus, a seat with elastic wires has been proposed, which can achieve a certain, but not good enough, damping effect. Moreover, since only one wire is provided on a seat plate, the seat plate has insufficient strength and poor bearing capacity.

Therefore, it is necessary to develop a damping device for a stroller, which can avoid the above problems in the prior art.

### SUMMARY

In view of the above defects in the prior art, an object of the present disclosure is to provide a damping device for a stroller, which can enable the stroller to achieve better damping effect.

As embodied and generally described herein, in order to achieve these and other advantages and according to the object of the present disclosure, a damping device of a stroller is provided. The damping device is arranged on a first pipe and a second pipe of a seat pipe of the stroller which are parallel to each other, and carries a seat part of the stroller. The damping device comprises a bracket structure pivotally connected to the first pipe and the second pipe, and the bracket structure is arranged to elastically prevent the bracket structure from pivoting relative to the first pipe and the second pipe by means of a damping elastic element to delay a downward movement of the seat part.

In one embodiment, the bracket structure comprises: a damping pipe abutting against a lower surface of the seat part, and having a fixed end pivotally connected to the first pipe and a free end that is higher than the second pipe; and a damping sleeve having a first end pivotally connected to the second pipe and a second end slidably pivotally connected to the damping pipe, the damping sleeve being arranged to be driven to pivot downward about the second pipe when the damping pipe is pressed downward and pivots downward about the first pipe; wherein the damping elastic element is a separate member other than the damping pipe and the damping sleeve, and the damping elastic element is arranged to apply a damping force on the damping pipe and/or the damping sleeve when the damping pipe and the damping sleeve pivot downward.

In one embodiment, the damping pipe is provided with a connecting sleeve which is slidable along the damping pipe, and the second end of the damping sleeve is pivotally connected to the connecting sleeve, so that the second end of the damping sleeve is indirectly pivotally connected to the damping pipe.

In one embodiment, the connecting sleeve is provided with a pin perforation which is transverse to the damping pipe, the second end of the damping sleeve is provided with a pin connecting hole, and a part of the damping pipe surrounded by the connecting sleeve is provided with an elongated-slot-shaped sliding hole, and a pin passes through the pin connecting hole, the pin perforation and the sliding hole in sequence.

In one embodiment, the connecting sleeve is provided with a damping sleeve hole in which the damping pipe slides, and a connecting column transverse to the damping pipe is arranged at a position of the connecting sleeve provided with the pin perforation, and the pin perforation penetrates through the connecting column; the first end of the damping sleeve is provided with a second sleeve hole through which the second pipe passes, the second end of the damping sleeve is provided with two limiting bosses, the pin connecting hole is formed by penetrating through the two limiting bosses, a limiting groove is defined between the two limiting bosses, and a part of the connecting sleeve provided with the connecting column is accommodated in the limiting groove.

In one embodiment, the damping elastic element is a torsion spring, the first end of the torsion spring is a pushing part acting on the damping pipe, and the second end of the torsion spring is a hook part engaged in an engaging hole of the damping sleeve, a ring-shaped collar wound by a spring wire of the torsion spring is provided between the pushing part and the hook part, and the collar is arranged on the connecting column of the connecting sleeve.

In one embodiment, a boss is provided at a lower part of the connecting sleeve and provided with a rotating hole, a pin connecting hole is provided at the second end of the damping sleeve, and a pin passes through the pin connecting hole and the rotating hole on the boss in sequence.

In one embodiment, an elongated-slot-shaped sliding hole is provided at a part of the damping pipe pivotally connected with the damping sleeve, and a pin connecting hole is provided at the second end of the damping sleeve, and a pin passes through the pin connecting hole and the sliding hole, so that the second end of the damping sleeve is directly pivotally connected to the damping pipe.

In one embodiment, the damping elastic element is a tension spring, a compression spring, a hydraulic rod or a pneumatic rod, which acts on the damping pipe and/or the damping sleeve to generate a damping force in response to downward pivoting of the damping pipe and the damping sleeve.

In one embodiment, the bracket structure of the damping device comprises: a damping pipe abutting against a lower surface of the seat part, and having a fixed end pivotally connected to the first pipe and a free end that is higher than the second pipe; a damping sleeve having a first end pivotally connected to the second pipe and a second end pivotally connected to the damping pipe; wherein the damping elastic element is a hydraulic rod or pneumatic rod forming a part of the damping sleeve, and when the damping sleeve is pressed downward and pivots downward about the first pipe, the damping sleeve is driven to pivot downward about the second pipe and apply a damping force on the damping pipe by means of the hydraulic rod or the pneumatic rod forming a part of the damping sleeve.

In another aspect, the present disclosure also provides a seat of a stroller, wherein the seat comprises the damping device as mentioned above.

In still another aspect, the present disclosure also provides a stroller, wherein the stroller comprises a frame and a seat arranged on the frame, and the seat comprises the damping device as mentioned above.

The beneficial effect of the present disclosure is that the damping device of the child stroller prevents the bracket structure from pivoting to delay the downward movement of the seat part, so that the stroller can achieve a better damping effect.

The foregoing and other objects, features, aspect and advantages of the present disclosure will become more apparent from the following detailed description of the present disclosure taken in conjunction with the accompanying drawings.

### BRIEF DESCRIPTION OF THE DRAWINGS

The accompanying drawings are included in the present disclosure to provide a further understanding of the present disclosure and are incorporated into and constitute a part of this specification, illustrate embodiments of the present disclosure, and serve to explain the concept of the present disclosure together with the following description.

In the drawings:

FIG. 1 is a perspective view of a frame of a stroller using a damping device according to an embodiment of the present disclosure.

FIG. 2 shows a perspective view of the frame of the stroller in FIG. 1 from another angle.

FIGS. 3 and 4 are simplified schematic views of the damping device according to the present disclosure.

FIG. 5 is a perspective view of a damping pipe according to an embodiment of the damping device of the present disclosure.

FIG. 6 is a perspective view of a connecting sleeve according to an embodiment of the damping device of the present disclosure.

FIG. 7 is a perspective view of a damping sleeve according to an embodiment of the damping device of the present disclosure.

FIG. 8 is a perspective view of a damping elastic element according to an embodiment of the damping device of the present disclosure.

FIG. 9 is a schematic cross-sectional view at a connection of various components according to an embodiment of the damping device of the present disclosure.

FIGS. 10 and 11 are schematic views of a damping device according to another embodiment of the present disclosure.

### LIST OF REFERENCE NUMBERS

10 damping pipe
10a fixed end
10b free end
11 sliding hole
20 damping sleeve
20a first end
20b second end
21 pin connecting hole
22 second sleeve hole
23 limiting boss
24 limiting groove
30 damping elastic element
31 pushing part
40 pin, pivot point
50 connecting sleeve
51 pin perforation
52 damping sleeve hole
53 connecting column
54 boss
100 seat pipe
101 first pipe
102 second pipe
103 pipe joint

### DETAILED DESCRIPTION

Hereinafter, exemplary embodiments will be described in detail with reference to the accompanying drawings. It can be understood that although terms such as “first” and “second” can be used to describe various elements, these elements are not limited by these terms. These terms are usually only used to distinguish one element from another. In addition, terms specifically defined in consideration of the construction and operation of embodiments are only used to describe the embodiments, and do not limit the scope of the embodiments.

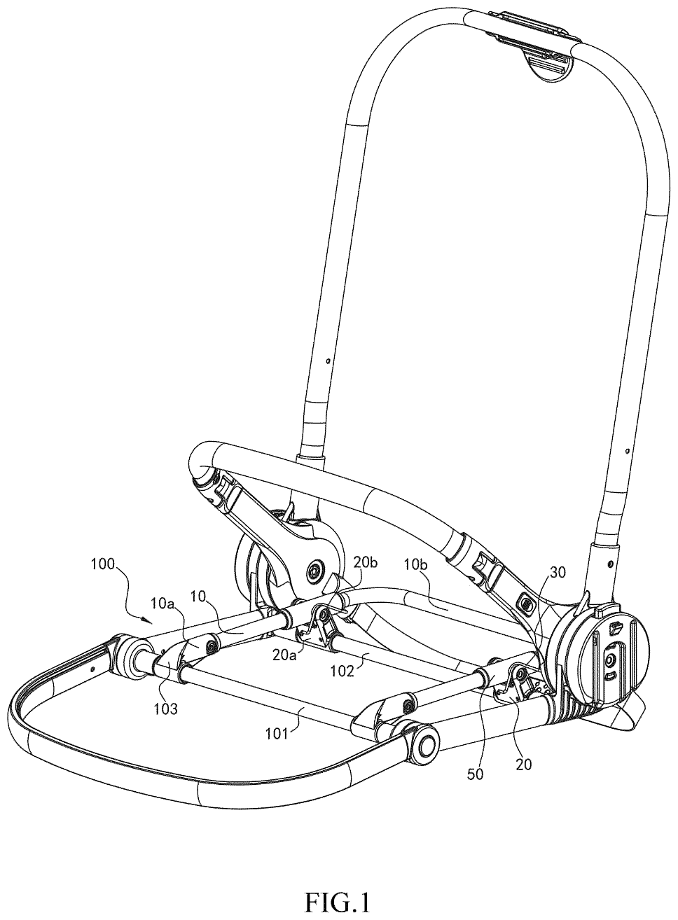

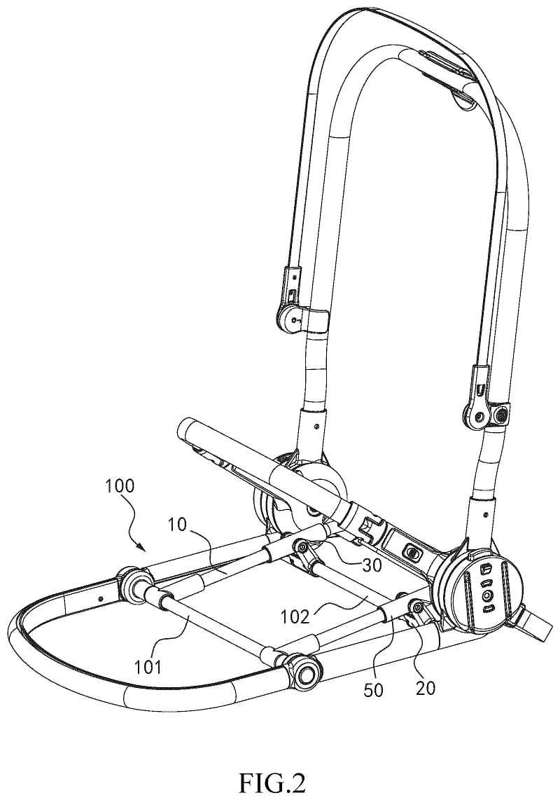

FIGS. 1 and 2 show a frame of a stroller using a damping device according to an embodiment of the present disclosure. The frame of the stroller comprises a seat pipe 100 for a seat part and a backrest pipe for a backrest part. The seat pipe 100 is a frame structure composed of a first pipe 101, a second pipe 102 and two connecting pipes connecting therebetween.

The damping device according to the present disclosure is provided on the first pipe 101 and the second pipe 102, and is used for carrying the seat part of the stroller. In this text, a direction towards which the stroller faces is defined as a forward direction, and a direction away from which the stroller faces is defined as a backward direction. It should be understood that, although as shown in FIGS. 1 and 2, the first pipe 101 is a front pipe, and the second pipe 102 is a rear pipe. However, the present disclosure is not limited thereto, and the first pipe 101 may be a rear pipe and the second pipe 102 may be a front pipe. In addition, the first pipe 101 and the second pipe 102 may also be two side pipes connecting the front pipe and the rear pipe.

The damping device comprises a bracket structure pivotally connected to the first pipe 101 and the second pipe 102 and a damping elastic element 30, and the bracket structure is arranged to elastically prevent the bracket structure from pivoting relative to the first pipe 101 and the second pipe 102 by means of the damping elastic element 30 to delay a downward movement of the seat part. As the present disclosure prevents the pivoting of the bracket structure to delay the downward movement of the seat part, the present disclosure enables the stroller to achieve a more stable and soothing damping effect compared with a manner of directly preventing the downward movement of the seat by applying resistance in an up-down direction.

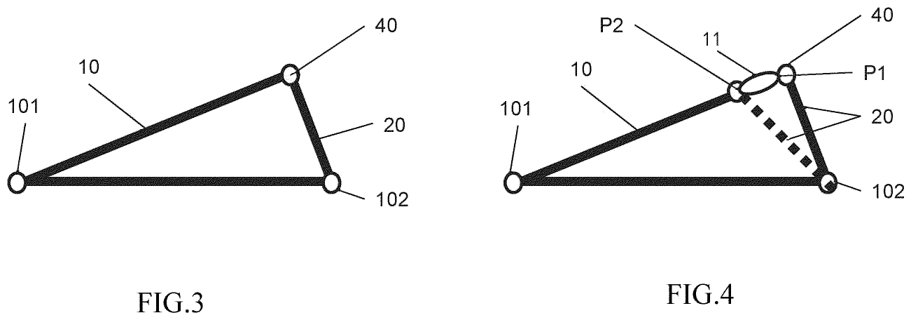

The bracket structure comprises a damping pipe 10 and a damping sleeve 20. The damping pipe 10 and the damping sleeve 20 are connected to each other to form a bracket structure that may move up and down (as shown in FIGS. 3 and 4). The damping elastic element 30 applies a damping force on the bracket structure in response to the downward movement of the bracket structure. Before the child sits on the seat part of the stroller, the damping elastic element 30 pushes up the bracket structure formed by the damping pipe 10 and the damping sleeve 20. After a child sits on the seat part of the stroller, the damping pipe 10 abutting against a lower surface of the seat part of the stroller is pressed down and pivots downward, and drives the damping sleeve 20 to pivot downward. At this time, the damping elastic element 30 applies a damping force on the damping pipe 10 and/or the damping sleeve 20 to reduce the vibration of the seat part of the stroller. Especially, when the stroller rides through the bumpy road, buttocks of the child may be bounced up and down, and in the falling process, the damping elastic element 30 can provide a good damping and buffering effect for the seat part of the stroller, so as to prevent the buttocks from being impacted too much and affect the riding comfort. Moreover, the support strength of the seat pipe of the stroller using the damping device is sufficient. In addition, after covering a seat cloth, not only the riding comfort can be further increased, but also the stress of the seat cloth will not be increased, so as to ensure the normal service life of the seat cloth.

The components of the damping device will be described in detail below.

The damping pipe 10 has a fixed end 10a and a free end 10b. The fixed end 10a is pivotally connected to the first pipe 101, and the free end 10b is higher than the second pipe 102, so that a plane defined by the damping pipe 10 and the first pipe 101 forms a certain angle with respect to a plane defined by the second pipe 102 and the first pipe 101. In the embodiment shown in FIG. 1, the fixed end 10a is pivotally connected to the first pipe 101 through a pipe joint 103. Of course, the fixed end 10a may be directly pivotally connected to the first pipe 101.

In addition, the damping pipe 10 shown in FIGS. 1, 2 and 5 is in a shape of U-shaped pipe. The open ends of the U-shaped pipe are two fixed ends 10a pivotally connected close to two ends of the first pipe 101 respectively, and the connecting end at the other end is higher than the free end 10b of the second pipe 102. The U-shaped damping pipe 10 and the first pipe 101 form a roughly square shape, so that the seat part can be uniformly loaded. Of course, the damping pipe 10 may also in other shapes, such as a shape of V-shaped pipe or a shape of straight pipe, which can also achieve the effect of the damping pipe 10. When the damping pipe 10 is in the shape of straight pipe, the fixed end 10a thereof is preferably pivotally connected to a middle of the first pipe 101.

In order to keep the plane defined by the damping pipe 10 and the first pipe 101 at a certain angle relative to the plane defined by the second pipe 102 and the first pipe 101, the damper device 100 further comprises a damping sleeve 20 which forms the bracket structure together with the damping pipe 10.

Referring to FIG. 1, the first end 20a of the damping sleeve 20 is pivotally connected to the second pipe 102, and the second end 20b is slidably pivotally connected to the damping pipe 10, so that when the damping pipe 10 is pressed downward and pivots downward around the first pipe 101, the damping sleeve 20 is also driven to pivot downward about the second pipe 102. In this text, “the second end 20b (of the damping sleeve 20) is slidably pivotally connected to the damping pipe 10” means that the second end 20b of the damping sleeve 20 is slidable along the damping pipe 10, and at the same time, the damping sleeve 20 can pivot about the second end 20b relative to the damping pipe 10.

The reason why the second end 20b of the damping sleeve 20 has to be slidably pivotally connected to the damping pipe 10 will be explained below with reference to FIGS. 3 and 4.

As shown in FIG. 3, the damping sleeve 20 is pivotally connected to the damping pipe 10 by a pin 40 passing through the second end 20b, so that the pin 40 forms a pivot point between the damping sleeve 20 and the damping pipe 10. Since a distance between the first pipe 101 and the second pipe 102 and a distance between the pivot point 40 and the second pipe 102 (i.e., a length of the damping sleeve 20) are constant, a triangle formed by the first pipe 101, the second pipe 102 and the pivot point 40 is constant if the distance between the pivot point 40 and the first pipe 101 is also constant. In this case, the damping pipe 10 and the damping sleeve 20 cannot pivot, and the bracket structure formed by the damping pipe 10 and the damping sleeve 20 cannot move up and down.

Therefore, the pivot point 40 needs to be able to slide relative to the damping pipe 10, so that the distance between the pivot point 40 and the first pipe 101 is variable. As shown in FIG. 4, the triangle formed by the first pipe 101, the second pipe 102 and the pivot point 40 is variable if the pivot point 40 can slide between a first position P1 and a second position P2. In this case, the damping pipe 10 and the damping sleeve 20 can pivot, and the bracket structure formed by the damping pipe 10 and the damping sleeve 20 can move up and down to provide damping and buffering effect.

In order to realize that the second end 20b of the damping sleeve 20, together with the pin 40 (i.e., the pivot point 40) passing therethrough, can slide relative to the damping pipe 10, the present disclosure may adopt various embodiments.

As shown in FIG. 1, the damping pipe 10 is provided with a connecting sleeve 50 which may slide along the damping pipe 10, and the second end 20b of the damping pipe 20 is pivotally connected to the connecting sleeve 50. In this case, the second end 20b of the damping pipe 20 is indirectly pivotally connected to the damping pipe 10 via the connecting sleeve 50.

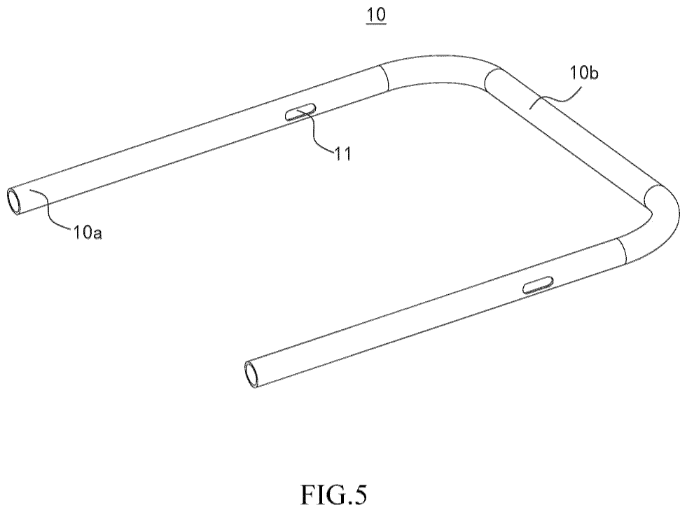

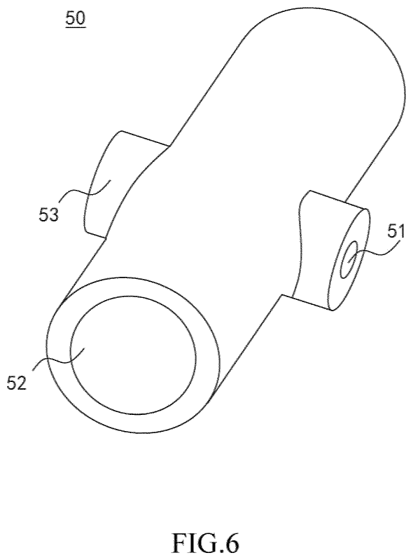

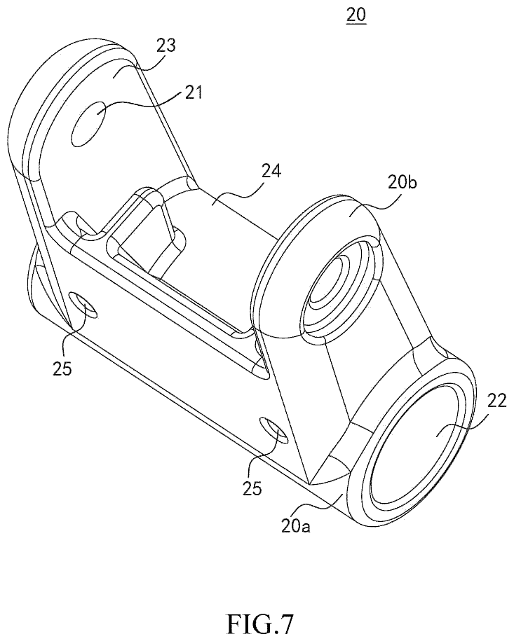

In a first embodiment of the damping device according to the present disclosure, the connecting sleeve 50 is provided with a pin perforation 51 (see FIG. 6) which is transverse to the damping pipe 10, the second end 20b of the damping pipe 20 is provided with a pin connecting hole 21 (see FIG. 7), and a part of the damping pipe 10 surrounded by the connecting sleeve 50 is provided with an elongated-slot-shaped sliding hole 11 (see FIG. 5), and the pin 40 passes through the pin connecting hole 21 on the damping sleeve 20, the pin perforation 51 on the connecting sleeve 50 and the sliding hole 11 on the damping pipe 10 in sequence, and acts as a pivot shaft between the damping sleeve 20 and the damping pipe 10. Meanwhile, the pin 40 is slidable in the elongated-slot-shaped sliding hole 11, so that the pivot point 40, i.e., the second end 20b of the damping sleeve 20 is slidable relative to the damping pipe 10.

FIG. 6 shows a connecting sleeve in the first embodiment of the damping device according to the present disclosure. The connecting sleeve 50 has a damping sleeve hole 52 in which the damping pipe 10 slides, and a connecting column 53 transverse to the damping pipe 10 is provided at a position of the connecting sleeve 50 provided with the pin perforation 51, and the pin perforation 51 penetrates through the connecting column 53, so that the connecting column 53 can support the pin 40 after the pin 40 passes through the pin perforation 51.

FIG. 7 shows a damping sleeve 20 in the first embodiment of the damping device according to the present disclosure, which is matched with the connecting sleeve 50 shown in FIG. 6. The first end 20a of the damping sleeve 20 is provided with a second sleeve hole 22 through which the second pipe 102 passes, and the second end 20b of the damping sleeve 20 is provided with two limiting bosses 23, and the pin connecting hole 21 is formed by penetrating through the two limiting bosses 23. A limiting groove 24 is defined between the two limiting bosses 23, and a part of the connecting sleeve 50 provided with the connecting column 53 is accommodated in the limiting groove 24.

In this embodiment, the pin 40 is supported by the connecting column 53 on the connecting sleeve 50 to slide in the sliding hole 11 on the damping pipe 10, avoiding the contact friction between the pin 40 and the sliding hole 11 which affects the service life.

Of course, the present disclosure is not limited thereto. The damping device according to the present disclosure may simplify the structure based on the first embodiment, and adopt a second embodiment in which the damping pipe 10 is not provided with the connecting sleeve 50. In the second embodiment with simplified structure, the elongated-slot-shaped sliding hole 11 is provided at a part of the damping pipe 10 pivotally connected with the damping sleeve 20, and the pin connecting hole 21 is provided at the second end 20b of the damping sleeve 20. The pin 40 passes through the pin connecting hole 21 and the sliding hole 11 in sequence and acts as a pivot point between the damping sleeve 20 and the damping pipe 10. In this case, the second end 20b of the damping sleeve 20 is directly pivotally connected to the damping pipe 10.

Since the pin 40 is also slidable in the elongated-slot-shaped sliding hole 11, the second embodiment with simplified structure also realizes that the pivot point 40, i.e., the second end 20b of the damping sleeve 20 is slidable relative to the damping pipe 10. However, since the contact friction between the pin 40 and the sliding hole 11 will affect the service life, the sliding hole 11 may be coated with a wear-resistant coating, or provided with a sliding block (not shown) matching with a shape of the sliding hole 11 and having a sliding groove, and the sliding block is preferably made of a wear-resistant material.

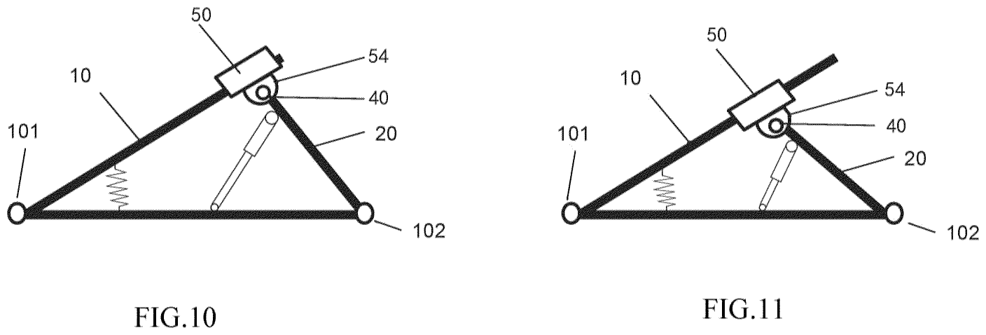

FIGS. 10 and 11 show a third embodiment of the damping device according to the present disclosure, in which the damping pipe 10 is not provided with the elongated-slot-shaped sliding hole 11, but the third embodiment can still realize that the second end 20b of the damping sleeve 20 may be slidably pivotally connected to the damping pipe 10.

Specifically, as shown in FIGS. 10 and 11, the damping pipe 10 is provided with a connecting sleeve 50 which is slidable along the damping pipe 10. A boss 54 is provided at a lower part of the connecting sleeve 50, and provided with a rotating hole. A pin connecting hole 21 is provided at the second end 20b of the damping pipe 20, and the pin 40 passes through the pin connecting hole 21 and the rotating hole on the boss 54 in sequence and acts as a pivot point between the damping sleeve 20 and the damping pipe 10. Meanwhile, the connecting sleeve 50 and the boss 54 thereon can slide along the damping pipe 10, so that the pivot point 40, i.e., the second end 20b of the damping sleeve 20 can slide relative to the damping pipe 10.

In addition, a stopping projection or stopper (not shown) may be provided on the damping pipe 10 to limit a sliding range of the connecting sleeve 50 along the damping pipe 10.

Next, the damping elastic element 30 in the damping device 100 will be described in detail.

In order to achieve the damping effect of the damping device 100, the damping elastic element 30 can apply a damping force to the damping pipe 10 and/or the damping sleeve 20 to slow down the downward movement of the bracket structure formed by the damping pipe 10 and the damping sleeve 20.

In the first, second and third embodiments of the damping device according to the present disclosure, the damping elastic element 30 is a separate member other than the damping pipe 10 and the damping sleeve 20.

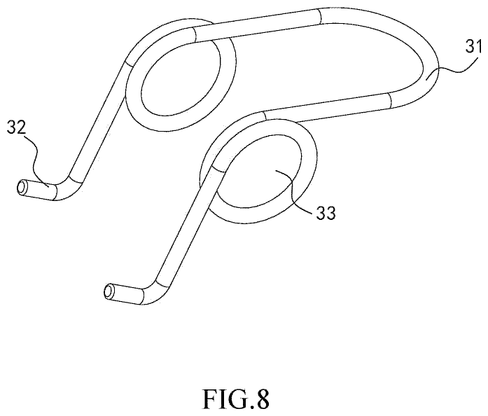

For example, in the first embodiment of the damping device according to the present disclosure, the damping elastic element 30 may be a torsion spring. As shown in FIG. 8, the first end of the torsion spring 30 is a pushing part 31 acting on the damping pipe 10, and the second end is a hook part 32 which can be engaged in an engaging hole 25 of the damping sleeve 20. A ring-shaped collar 33 wound by a spring wire of the torsion spring 30 is provided between the pushing part 31 and the hook part 32 of the torsion spring 30, and the collar 33 may be arranged on the connecting column 53 of the connecting sleeve 50.

Next, the operation of the damping device according to the present disclosure will be described in detail with reference to the first embodiment.

When the damping device is not under pressure from the seat part of the stroller, as shown in FIG. 1, the bracket structure formed by the damping pipe 10 and the damping sleeve 20 is kept at a high position under the action of the torsion spring 30.

When the damping device is under the pressure from the seat part of the stroller, the damping pipe 10 pivots downward about the first pipe 101, thereby driving the damping sleeve 20 to pivot downward about the second pipe 102, and at the same time, the connecting sleeve 50 slides along the damping pipe 10 from the position P1 to the position P2 (see FIG. 4).

Consequently, the bracket structure formed by the damping pipe 10 and the damping sleeve 20 moves to a low position. In this process, the torsion spring 30 applies a damping force on the damping pipe 10 and the damping sleeve 20, thereby greatly slowing down the speed and strength of the bracket structure moving to the low position and weakening the vibration of the seat part of the stroller.

When the pressure on the damping device weakens or disappears, the bracket structure will move back from the low position to the high position under the action of the torsion spring 30.

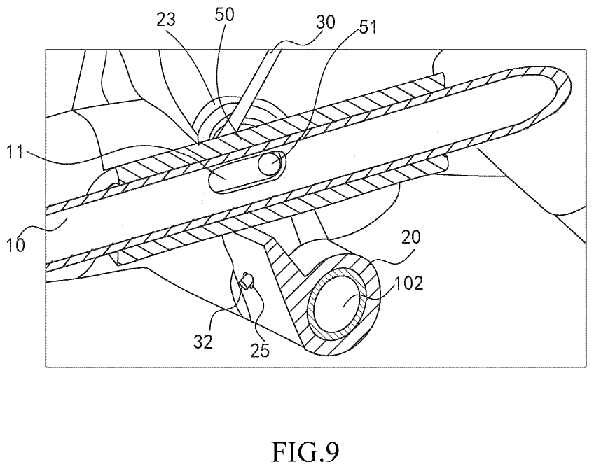

FIG. 9 shows in detail a state when the damping pipe 10, the damping sleeve 20, the torsion spring 30 and the connecting sleeve 50 are assembled in the first embodiment of the damping device according to the present disclosure, wherein the torsion spring 30 applies a damping force on the damping pipe 10 and the damping sleeve 20 at their connection.

The operation of the second embodiment of the damping device according to the present disclosure may be generally the same as that of the first embodiment, except that the specific arrangements of some components are changed. For example, since the connecting sleeve 50 is not provided on the damping pipe 10, the torsion spring 30 may be provided in other ways as long as it can apply a damping force on the connection of the damping pipe 10 and the damping sleeve 20.

In addition, the damping elastic element 30 is not limited to a torsion spring, but may also be various elastic bodies that may generate a damping force, such as a tension spring, a compression spring, a hydraulic rod or a pneumatic rod. Furthermore, the damping elastic element 30 may be a single piece acting only on the damping pipe 10 or the damping sleeve 20, or a single piece or multiple pieces acting on both the damping pipe 10 and the damping sleeve 20, as shown in FIGS. 10 and 11, which can generate a damping force in response to the downward pivoting of the damping pipe 10 and the damping sleeve 20.

In a fourth embodiment of the damping device according to the present disclosure, the damping elastic element is not a separate member other than the damping pipe 10 and the damping sleeve 20, for example, the damping elastic element is a hydraulic rod or a pneumatic rod forming a part of the damping sleeve 20. One end of the hydraulic rod or pneumatic rod is pivotally connected to the second pipe 102, and the other end is pivotally connected to the damping pipe 10. When the damping pipe 10 is pressed downward and pivots downward about the first pipe 101, the damping sleeve 20 will be driven to pivot downward about the second pipe 102 and apply a damping force on the damping pipe 10 by means of the hydraulic or pneumatic rod forming a part of the damping sleeve 20. In this case, the damping sleeve 20 has functions of both the damping sleeve and the damping elastic element, so that the separate damping elastic element 30 can be omitted. This embodiment reduces the cost by reducing the number of components of the damping device.

The stroller using the damping device according to the present disclosure will achieve a better damping effect, thereby improving the comfort of the child when riding.

The features of the present disclosure can be embodied in various forms without departing from the characteristics of the present disclosure, it should also be understood that the above-mentioned embodiments are not limited to any details described above, unless otherwise indicated, but should be broadly interpreted as being within the scope defined by the appended claims. Therefore, all modifications and alterations that fall within the scope and limits of the claims or the equivalent of such scope and limits should be covered by the appended claims.

1. A damping device of a stroller, arranged on a first pipe and a second pipe of a seat pipe of the stroller which are parallel to each other, and carrying a seat part of the stroller, wherein the damping device comprises a bracket structure pivotally connected to the first pipe and the second pipe, and the bracket structure is arranged to elastically prevent the bracket structure from pivoting relative to the first pipe and the second pipe by means of a damping elastic element to delay a downward movement of the seat part,
wherein the bracket structure comprises:
a damping pipe having a fixed end pivotally connected to the first pipe; and
a damping sleeve having a first end pivotally connected to the second pipe and a second end slidably pivotally connected to the damping pipe.

2. The damping device according to claim 1, wherein:
the damping pipe abuts against a lower surface of the seat part, and has a free end that is higher than the second pipe;
the damping sleeve is arranged to be driven to pivot downward about the second pipe when the damping pipe is pressed downward and pivots downward about the first pipe; and
the damping elastic element is a separate member other than the damping pipe and the damping sleeve, and the damping elastic element is arranged to apply a damping force on the damping pipe and/or the damping sleeve when the damping pipe and the damping sleeve pivot downward.

3. The damping device according to claim 1, wherein the damping pipe is provided with a connecting sleeve which is slidable along the damping pipe, and the second end of the damping sleeve is pivotally connected to the connecting sleeve, so that the second end of the damping sleeve is indirectly pivotally connected to the damping pipe.

4. The damping device according to claim 3, wherein the connecting sleeve is provided with a pin perforation which is transverse to the damping pipe, the second end of the damping sleeve is provided with a pin connecting hole, and a part of the damping pipe surrounded by the connecting sleeve is provided with an elongated-slot-shaped sliding hole, and a pin passes through the pin connecting hole, the pin perforation and the sliding hole in sequence.

5. The damping device according to claim 4,
wherein the connecting sleeve is provided with a damping sleeve hole in which the damping pipe slides, and a connecting column transverse to the damping pipe is arranged at a position of the connecting sleeve provided with the pin perforation, and the pin perforation penetrates through the connecting column;
wherein the first end of the damping sleeve is provided with a second sleeve hole through which the second pipe passes, the second end of the damping sleeve is provided with two limiting bosses, the pin connecting hole is formed by penetrating through the two limiting bosses, a limiting groove is defined between the two limiting bosses, and a part of the connecting sleeve provided with the connecting column is accommodated in the limiting groove.

6. The damping device according to claim 5, wherein the damping elastic element is a torsion spring, the first end of the torsion spring is a pushing part acting on the damping pipe, and the second end of the torsion spring is a hook part engaged in an engaging hole of the damping sleeve, a ring-shaped collar wound by a spring wire of the torsion spring is provided between the pushing part and the hook part, and the collar is arranged on the connecting column of the connecting sleeve.

7. The damping device according to claim 3, wherein a boss is provided at a lower part of the connecting sleeve and provided with a rotating hole, a pin connecting hole is provided at the second end of the damping sleeve, and a pin passes through the pin connecting hole and the rotating hole on the boss in sequence.

8. The damping device according to claim 1, wherein an elongated-slot-shaped sliding hole is provided at a part of the damping pipe pivotally connected with the damping sleeve, and a pin connecting hole is provided at the second end of the damping sleeve, and a pin passes through the pin connecting hole and the sliding hole, so that the second end of the damping sleeve is directly pivotally connected to the damping pipe.

9. The damping device according to claim 1, wherein the damping elastic element is a tension spring, a compression spring, a hydraulic rod or a pneumatic rod, which acts on the damping pipe and/or the damping sleeve to generate a damping force in response to downward pivoting of the damping pipe and the damping sleeve.

10. The damping device according to claim 1, wherein:
the damping pipe abuts against a lower surface of the seat part, and has a free end that is higher than the second pipe; and
the damping elastic element is a hydraulic rod or pneumatic rod forming a part of the damping sleeve, and when the damping pipe is pressed downward and pivots downward about the first pipe, the damping sleeve is driven to pivot downward about the second pipe and apply a damping force on the damping pipe by means of the hydraulic rod or the pneumatic rod forming a part of the damping sleeve.

11. A seat of a stroller, wherein the seat comprises the damping device according to claim 1.

12. A stroller, wherein the stroller comprises a frame and a seat arranged on the frame, and the seat comprises the damping device according to claim 1.

13. The damping device according to claim 8, wherein the sliding hole is coated with a wear-resistant coating, or provided with a sliding block matching with a shape of the sliding hole and having a sliding groove, and the sliding block is made of a wear-resistant material.

14. The damping device according to claim 3, wherein a stopping projection or stopper is provided on the damping pipe to limit a sliding range of the connecting sleeve along the damping pipe.

15. The damping device according to claim 1, wherein
when the damping device is not under pressure, the bracket structure is kept at a high position under the action of the damping elastic element,
when the damping device is under the pressure, the damping pipe pivots downward about the first pipe, thereby driving the damping sleeve to pivot downward about the second pipe, so that the bracket structure moves to a low position,
when the pressure on the damping device weakens or disappears, the bracket structure will move back from the low position to the high position under the action of the damping elastic element.
